(19) United States
(12) Patent Application Publication
(10) Pub. No.: US 2026/0296939 A1
(43) Pub. Date: Oct. 1, 2026

(54) SYSTEMS FOR CATALYTICALLY REMOVING PER- AND POLYFLUOROALKYL SUBSTANCES FROM A FLUID AND RELATED METHODS

(71) Applicants: Chen ZHOU, Chandler, AZ (US); Bruce RITTMANN, Tempe, AZ (US); Yihao LUO, Phoenix, AZ (US); Min LONG, Tempe, AZ (US)

(72) Inventors: Chen ZHOU, Chandler, AZ (US); Bruce RITTMANN, Tempe, AZ (US); Yihao LUO, Phoenix, AZ (US); Min LONG, Tempe, AZ (US)

(73) Assignee: ARIZONA BOARD OF REGENTS ON BEHALF OF ARIZONA STATE UNIVERSITY, Scottsdale, AZ (US)

(21) Appl. No.: 19/697,121

(22) Filed: Jun. 3, 2026

Related U.S. Application Data
(62) Division of application No. 18/573,844, filed on Jun. 23, 2022.
(60) Provisional application No. 63/214,140, filed on Jun. 23, 2021.

(51) Int. Cl. C02F 3/34; B01D 69/02; B01D 69/08; B01D 71/26; C02F 3/10; C02F 3/26; C02F 101/36; C02F 103/06

(52) U.S. Cl. CPC C02F 3/341; B01D 69/02; B01D 69/081; B01D 71/262; C02F 3/102; C02F 3/106; C02F 3/26; C02F 3/348; B01D 2255/1023; C02F 2101/36; C02F 2103/06; C02F 2203/004; C02F 2203/006; C02F 2209/44; C02F 2305/08

(57) ABSTRACT

The present invention relates to systems and methods for catalytic removal of per- and polyfluoroalkyl substances (PFAS) from water and wastewater. The system and methods utilize a catalyst film and a biofilm to synergistically remove PFAS from water. In some aspects, the catalyst film reduces and defluorinates PFAS into less fluorinated counterparts of PFAS, and the biofilm metabolizes the less fluorinated counterparts of PFAS into CO₂ or shorter chain PFAS.

### CROSS-REFERENCE TO RELATED APPLICATIONS

This application is a divisional of U.S. patent application Ser. No. 18/573,844, filed Dec. 22, 2023, which is a U.S. National Phase Entry of International Patent Application PCT/US2022/034774, filed Jun. 23, 2022, which claims the benefit of and priority to U.S. Provisional Application No. 63/214,140, filed Jun. 23, 2021, the contents of each of which are incorporated herein by reference in their entirety.

### FIELD OF THE INVENTION

The invention relates to systems and methods for removing per- and polyfluoroalkyl substances (PFAS) from water or wastewater.

### BACKGROUND OF THE INVENTION

The per- and polyfluoroalkyl substances (PFAS, CₙF₂ₙ₊₁—R) refer to a family of manmade chemicals that have been produced since the 1940s. PFAS were developed in the early 1940s to be used as refrigerants and flame retardants and in materials such as fabrics and food packaging, resulting in large quantities being introduced into the environment. In 1969, they became the dominant agent for fighting fires at airports and military installations to meet MIL-F-24385 specifications. For example, perfluorooctanoic acid (PFOA), one of the most widely used PFAS compounds, has been used as a refrigerant, in fabrics and food packaging, and as a flame retardant at airports and military installations.

The widespread applications of PFAS have led to large-scale contamination of soil and groundwater throughout the world. The presence of perfluorinated chemicals in food, human serum, groundwater, and various animal species is of great concern due to their deleterious impacts on environmental and human health. It has negative impacts on human and ecosystem health and has been detected in blood serum. Based on toxicity tests and risk assessments, the USEPA set an interim health advisory level at 0.004 ppt of PFOA, 0.02 ppt of perfluorooctanesulfonic acid (PFOS), final health advisory at 10 ppt of GenX chemicals and 2000 ppt of PFBS for drinking water. The primary producers of PFOA and PFOS are fluoropolymer and ammonium salt of perfluorooctanoic acid manufacturers, who are responsible for the release of ~85% of all PFAS.

Adsorption and filtration are the most common approaches for removing PFAS from groundwater in practice today. These approaches do not destroy PFAS. Further processing is needed to dispose of the concentrated PFAS. Destroying or converting PFAS to less-toxic compounds would be more sustainable. The key challenge for destroying PFAS lies in their notorious recalcitrance that is linked to the high dissociation energy (440.99 kJ/mole) of the carbon-fluorine (C—F) bond. Although biodegradation of some PFAS has been reported, slow rates (typically over 100 days for substantial depletion or no F⁻ detected) hinder practical applications. Other destruction methods, such as sonication, thermal treatment, and chemical oxidation, are able to break the C—F bonds, but they generally require high investment costs and a high requirement for energy, temperature, or pressure, and they often give rise to hazardous secondary pollution. Only a few studies reported the alternative reductive defluorination using chemical reducing agents like ZVI (zero-valent iron) or titanium (III) citrate for PFAS removal. These reductive methods are hindered by low efficiency or activity, secondary contaminants, and poorly understood mechanisms.

Accordingly, novel methods of removing PFAS contaminants are needed. PFAS treatment methods that overcome these crucial roadblocks would be major benefits for the ammunition-related water/wastewater-treatment industry.

### SUMMARY OF THE INVENTION

The disclosure relates to methods related to the removal of per- and polyfluoroalkyl substances (PFAS) from contaminated water or wastewater and to systems for the practice of such methods. In some aspects, the methods are directed to the formation of a catalyst film capable of reduction defluorination of PFAS. In other aspects, the methods are directed to the formation of a biofilm that metabolizes less fluorinated counterparts of PFAS. The described systems for the removal of PFAS is synergistic system comprising a reactor with a catalyst film that reduces PFAS to less fluorinated counterparts of PFAS and a reactor with a biofilm that metabolizes less fluorinated counterparts of PFAS into CO₂. The systems enable controlled bubbleless H₂ delivery through a gas-transfer membrane to the catalyst film and controlled bubbleless O₂ delivery through a gas-transfer membrane to the biofilm.

The system for removing PFAS from a fluid comprises a first reactor and a second reactor, wherein the first reactor and the second reactor are in fluid connection. For example, the fluid flows from the first reactor to the second reactor. In particular implementations, the fluid flows at a hydraulic retention time (HRT) of no more than 24 hours.

In some embodiments of the system, the first reactor comprises a monometallic catalyst film that reduces PFAS to less fluorinated counterparts; a first nonporous membrane comprising a gas-phase side and a liquid-phase side; and a hydrogen (H₂) gas source. The monometallic catalyst film comprises nanoparticles of a precious metal, wherein the nanoparticles have diameters of less than 10 nm. The catalyst film is deposed (for example, deposited) on the liquid-phase side of the first nonporous membrane. The H₂ gas source delivers H₂ to the gas-phase side of the first nonporous membrane and the nanoparticles and the H₂ gas catalyze reductive defluorination of PFAS. The second reactor comprises: a biofilm that metabolizes the less fluorinated counterparts of PFAS; a second nonporous membrane comprising gas-phase side and a liquid-phase side; and an oxygen (O₂) gas source. The biofilm is deposed (for example, anchored) on the liquid-phase of the second nonporous membrane. In some aspects, the biofilm comprises heterotrophic bacteria capable of oxidizing partially fluorinated or non-fluorinated alkyl acids. The O₂ gas source delivers O₂ to the gas-phase side of the second non-porous membrane.

In other embodiments of the system, the first reactor comprises: a catalyst-precursor medium comprising a precious metal salt and a liquid solvent; a hydrogen (H₂) gas source; and a first nonporous membrane comprising a gas-phase side and a liquid-phase side. The liquid-phase side of the first nonporous membrane is in fluid contact with the catalyst-precursor medium, and the H₂ gas source delivers hydrogen gas to the gas-phase side of the first nonporous membrane thereby reducing the precious metal salt in the catalyst-precursor medium into the elemental form of the precious metal. In some aspects, the precious metal concentration in the catalyst-precursor medium is 0.01-100 mM. In some aspects, the pH of the catalyst-precursor medium is 6-8. The elemental form of the precious metal is deposed (for example, deposited) on the liquid-phase side of the first nonporous membrane. In such embodiments, the second reactor comprises: a microorganism-enrichment medium comprising an organic carbon source; an inoculant comprising heterotrophs capable of oxidizing partially fluorinated or non-fluorinated alkyl acids; an oxygen (O₂) gas source; and a second nonporous membrane comprising gas-phase side and a liquid-phase side. The liquid-phase side of the second nonporous membrane is in fluid contact with the microorganism-enrichment medium, and the O₂ gas source delivers oxygen to the gas-phase side of the second nonporous membrane. The heterotrophs capable of oxidizing partially fluorinated or non-fluorinated alkyl acids produces a biofilm on the liquid-phase side of the nonporous membrane in the presence of the microorganism-enrichment medium.

In particular embodiments of the systems for removing PFAS from fluid, the nanoparticles of the precious metal on the monometallic catalyst film have diameters of less than 5 nm or less than 3 nm. In some aspects, the monometallic catalyst film comprises nanoclusters of the nanoparticles, wherein the nanoparticles have diameters of less than 0.1 nm and the nanoclusters have diameters of 2-3 nm. In certain embodiments, the precious metal is a platinum group metal, for example, palladium.

In some embodiments, the nonporous membranes are made of a polymeric material selected from the group consisting of: polypropylene, polyurethane, polysulfone, and composite forms. In some aspects, the nonporous membranes are hollow-fiber membranes. In particular implementations, the hollow-fiber membranes have a wall thickness 50-55 μm. In some aspects, the outer diameter of the hollow-fiber membranes is 200 μm and/or the inner diameter of the hollow-fiber membranes is 100-110 μm.

The method of removing PFAS from a fluid comprising contacting a fluid comprising PFAS with a monometallic catalyst film to produce a fluid comprising less fluorinated counterparts of PFAS, wherein the monometallic catalyst film comprises nanoparticles of a precious metal with diameters of less than 10 nm; and contacting the fluid comprising less fluorinated counterparts of PFAS with a biofilm comprising microorganisms that metabolizes the less fluorinated counterparts of PFAS to produce a fluid comprising CO₂. In some aspects the fluid comprising PFAS flows at a hydraulic retention time (HRT) of no more than 24 hours.

In some aspects, the method further comprises providing a first nonporous membrane having a gas-phase side and a liquid-phase side; contacting the liquid-phase side of the first nonporous membrane with a catalyst-precursor medium comprising a precious metal salt and a solvent; and contacting the gas-phase side of the first nonporous membrane with hydrogen (H₂) gas at a sufficient partial pressure to convert at least 90% of the precious metal salt in the precious metal medium to elemental form. The elemental form of the precious metal is in the form of nanoparticles and is deposed (for example, deposited) on the liquid-phase side of the first nonporous membrane to form the monometallic catalyst film. In certain implementations, the precious metal is a platinum group metal, for example, palladium. In some aspects, the precious metal concentration in the catalyst-precursor medium is 0.01-100 mM. In some aspects, the catalyst-precursor medium is 6-8.

In some implementations, the method further comprises submerging a second nonporous membrane with a microorganism-enrichment medium comprising an organic carbon source; contacting an inoculant with the second nonporous membrane, wherein the inoculant comprises heterotrophs capable of oxidizing partially fluorinated or non-fluorinated alkyl acids; and pressurizing the gas-phase side of the second nonporous membrane with oxygen (O₂) gas at desired partial pressure. A biofilm that metabolizes the less fluorinated counterparts of PFAS is formed on the liquid-phase side of the second nonporous membrane. In some aspects, the microorganism-enrichment medium further comprises salts of macronutrients, salts of micronutrients, and/or phosphate salts.

In particular implementations of the method of removing PFAS from a liquid, the first nonporous membrane is in a first reactor and the second nonporous membrane is in a second reactor. The second reactor is in fluid connection with the first reactor.

The method of producing a synergistic system for removing PFAS from a fluid comprises forming a catalyst film and forming a biofilm, wherein the catalyst film reduces PFAS to produce less fluorinated counterparts of PFAS and the biofilm metabolizes the less fluorinated counterparts of PFAS. In some aspects, the catalyst film formed is in a first reactor, and the biofilm filmed is in a second reactor, wherein the first reactor and the second reactor are in fluid connection.

The steps for forming the catalyst film comprises providing a first nonporous membrane having a gas-phase side and a liquid-phase side; contacting the liquid-phase side of the first nonporous membrane with a catalyst-precursor medium; contacting the gas-phase side of the first nonporous membrane with hydrogen (H₂) gas at a sufficient partial pressure to convert at least 90% of the precious metal salt in the precious metal medium to elemental form. The elemental form of the precious metal is in the form of nanoparticles with diameters of less than 10 nm and the precious metal nanoparticles are deposited (for example, deposited) on the liquid-phase side of the first nonporous membrane to form the catalyst film. The catalyst-precursor medium comprises a precious metal salt and a solvent. Accordingly, in some aspects, the first nonporous membrane is in a first reactor. In certain implementations, the precious metal is a platinum group metal.

The steps for forming the biofilm comprises providing a second nonporous membrane having a gas-phase side and a liquid-phase side; submerging the second nonporous membrane with a microorganism-enrichment medium comprising an organic carbon source; contacting an inoculant with the liquid-phase side of the second nonporous membrane, wherein the inoculant comprises heterotrophs capable of oxidizing partially fluorinated or non-fluorinated alkyl acids; and pressurizing the gas-phase side of the second nonporous membrane with oxygen (O₂) gas at desired partial pressure thereby forming the biofilm on the liquid-phase side of the second nonporous membrane. Accordingly, in some aspects, the second nonporous membrane is in a second reactor.

The method of establishing a catalyst film for reductive defluorination of PFAS in a fluid comprises: providing a nonporous membrane having a gas-phase side and a liquid-phase side; contacting the liquid-phase side of the nonporous membrane with a catalyst-precursor medium comprising a palladium salt and a solvent; and contacting the gas-phase side of the nonporous membrane with hydrogen (H₂) gas at a sufficient partial pressure to convert at least 90% of the palladium salt in the precious metal medium to elemental form. The concentration of palladium in the catalyst-precursor medium is 0.01-100 mM. The elemental form of palladium is in the form of nanoparticles with a diameter of less than 0.1 nm and nanoclusters with diameters of less than 5 nm, and the nanoparticles and nanoclusters are deposited on the liquid-phase side of the nonporous membrane to form the catalyst film.

In some implementation of the method of establishing a catalyst film for reductive defluorination of PFAS, the precious metal concentration in the catalyst-precursor medium is 0.1-100 mM. In some aspects, the pH of the catalyst-precursor medium is 6-8.

In some aspects, the nonporous membranes are made of a polymeric material selected from the group consisting of: polypropylene, polyurethane, polysulfone, and composite forms. In particular embodiments, the nonporous membranes are hollow-fiber membranes. In some aspects, the wall thickness of the hollow-fiber membranes is 50-55 μm. In some implementations, the outer diameter of the hollow-fiber membranes is 200 μm and/or the inner diameter of the hollow-fiber membranes is 100-110 μm.

### BRIEF DESCRIPTION OF THE DRAWINGS

FIGS. 1A-1F depict, in accordance with certain embodiments, solid-state characteristics of fiber samples in palladium catalyst film. FIG. 1A is a TEM image of a cross-section of the Pd-fiber. FIG. 1B is a TEM image of the boundary of the Pd-fiber. FIG. 1C shows the lattice fingers of the nanoparticles. FIG. 1D depicts the size distribution of the nanoparticles of FIG. 1B. FIG. 1E shows the XRD spectra of the Pd-fiber. FIG. 1E shows the XPS spectra of Pd-fiber.

FIGS. 2A-2C depict, in accordance with certain embodiments, the changes of PFOA and F⁻ concentration over time of initial 0.1 mM PFOA and released F⁻ with H₂ delivery (FIG. 2A) without and (FIG. 2B) with the Pd catalyst (0.9 g/m2 areal loading), and (FIG. 2C) with N₂ delivery with the Pd⁰ catalyst. Reaction conditions: pH 4 and MCfR operating with recirculating flow rate of 150 mL/min.

FIG. 3 depicts, in accordance with certain embodiments, the change of PFOA and F-concentrations over time in the extended batch test for 0.9 g/m² Pd at pH 4 in the MCfR supplied with 20 psig N₂ for 6 days followed by 20 psig H₂ for 8 days. The arrow refers to PFOA re-spiking into the liquid in the MCfR on day 12.

FIGS. 4A-4D, depicts, in accordance with certain embodiments, two distinct possible adsorption mechanisms of PFOA. Perpendicular (non-defluorinative; FIGS. 4A and 4C) and parallel (defluorinative; FIGS. 4B and 4D) adsorption modes of PFOA to the Pd (111) surface at different conditions along with respective adsorption energies (in eV). Shaded adsorption modes represent the less favorable mode for each condition. The horizontal bars represent Pd⁰ surfaces. The H connected on the Pd⁰ represents activated H*. The circles identify PFOA's carboxyl heads.

FIGS. 5A-1-5D depict, PFOA and F⁻ concentrations over time in the sequential-batch tests for 0.9 g/m² Pd at pH 4 in two MCfRs supplied with 20 psig N₂ (FIGS. A1-A3) and H₂ (FIGS. B1-B3), respectively. FIGS. 5C and 5D show the ratio of removal and first-order rate constants, respectively, of the batch tests.

FIGS. 6A and 6B depict, in accordance with certain embodiments, the concentrations of PFOA and F⁻ in the effluents of two continuously operated MCfRs loaded with identical 0.9 mg/m² Pd⁰NPs and supplied with 20 psig N₂ (FIG. 6A) and H₂ (FIG. 6B).

FIG. 7 depicts, in accordance with certain embodiments, HPLC-QTOF-MS results for Pd⁰-catalyzed reduction of PFOA.

FIG. 8 depicts, in accordance with certain embodiments, the breakthrough curve for non-defluorinative adsorption of PFOA on Pd0 NPs in an MCfR.

FIG. 9 depicts, in accordance with certain embodiments, the schematic of a typical bench-scale form of the first reactor comprising the catalyst film. The reactor was first filled with a 5 mM Na₂PdCl₄ solution. Then, the H₂ supply was turned on with a pressure of 10 psig (1.68 atm absolute pressure), and then the recirculation pump was activated. Autocatalytic reduction of Pd²⁺ to PdNPs occurred directly on the membranes, and complete reduction and deposition required 6 hours. After catalyst synthesis, deionized water was used to remove any suspended PdNPs and residual Pd²⁺ or Cl⁻.

FIG. 10 depicts, in accordance with certain embodiments, the schematic of a typical bench-scale form of the second reactor comprising the biodegradation parts.

FIGS. 11A and 11B depict, in accordance with certain embodiments, the continuous operation for fluorinated and non-fluorinated OA biodegradation in the O₂-MBfR. The arrows mark the time of biofilm sample collection.

FIG. 12 depicts, in accordance with certain embodiments, the schematic of a typical bench-scale form of the synergistic system comprising the first and the second reactors.

FIG. 13 depicts, in accordance with certain embodiments, continuous operation in the O₂-MBfR for biodegradation of the MCfR effluent.

### DETAILED DESCRIPTION OF THE INVENTION

Detailed aspects and applications of the invention are described below in the drawings and detailed description of the invention. Unless specifically noted, it is intended that the words and phrases in the specification and the claims be given their plain, ordinary, and accustomed meaning to those of ordinary skill in the applicable arts.

In the following description, and for the purposes of explanation, numerous specific details are set forth in order to provide a thorough understanding of the various aspects of the invention. It will be understood, however, by those skilled in the relevant arts, that the present invention may be practiced without these specific details. It should be noted that there are many different and alternative configurations, devices, and technologies to which the disclosed inventions may be applied. The full scope of the inventions is not limited to the examples that are described below.

The singular forms “a,” “an,” and “the” include plural referents unless the context clearly dictates otherwise. Thus, for example, reference to “a step” includes reference to one or more of such steps.

The term “about” when used in the context of numeric values denotes an interval of accuracy that is familiar and acceptable to a person skilled in the art. The interval is ±10% of the given numeric value, ±5% of the given numeric value, or ±2% of the given numeric value.

As used herein, the term “precious metal” refers to gold (Au), silver (Ag), and platinum group metals (PGM). The members of PGM include platinum (Pt), palladium (Pd), ruthenium (Ru), and rhodium (Rh).

As used herein, the term “catalyst film” refer to a film of precious metal nanocatalysts.

As used herein, the term “nanocluster” refers to a cluster of nanoparticles. In some aspects, the nanoclusters have diameters of less than 10 nm, less than 5 nm, less than 3 nm, or 2-3 nm.

The strong carbon-fluorine (C—F) bond energy (~485 kJ mol⁻¹) makes per- and polyfluoroalkyl substances (PFAS) persistent to oxidation, and no successful completely biodegradation has been documented until the present disclosure. Although advanced oxidation/reduction processes, photocatalysis, and thermal destruction can convert the PFAS into less-fluorinated and/or shorter-chained compounds, these approaches add or generate hazardous materials, are very energy-consuming, or both. Removal of the fluorine (F) substituents makes PFAS, such as perfluorooctanoic acid (PFOA) and perfluorooctanesulfonic acid (PFOS), biodegradable, but the first step, reductive defluorination, requires the use of an efficient catalyst.

PFAS include but are not limited to: perfluorodoctanoic acid (PFOA), perfluorooctanesulfonic acid (PFOS), perfluorobutanoic acid (PFBA), perfluorohexanoic acid (PFHxA), 6:6 perfluoroalkyl phosphinic acids (6:6 PFPiA), 8:8 perfluoroalkyl phosphinic acids (8:8 PFPiA), perfluoroalkyl ether carboxylic acid (PFECA), and perfluorinated phosphonic acid (PFPA), 6:2 fluorotelomer alcohol (6:2 FTOH), 8:2 fluorotelomer alcohol (8:2 FTOH), ammonium perfluoro-2-propoxypropionate (GenX), 6:2 chlorinated polyfluorinated ether sulfonate (F-53B), n-methyl perfluorooctane sulfonamide (MeFOSA), N-ethyl perfluorooctane sulfonamidoethanol (N-EtFOSE), perfluorooctane sulfonamidoethanol-based phosphate (SAmPAP), 10:2 fluorotelomer alcohol (10:2 FTOH), 12:2 fluorotelomer alcohol (12:2 FTOH), 6:2 polyfluoroalkyl phosphate diester (6:2 diPAP), 8:2 polyfluoroalkyl phosphate diester (8:2 diPAP), and perfluoropolyalkylether N, N-diphenylamide (PFPEA).

Described herein is the first method that can completely mineralize PFAS to H₂O, CO₂, and F⁻ and related systems. The disclosed method of removing per- and polyfluoroalkyl substances (PFAS) from a fluid utilizes a film of nanocatalysts (the catalyst film) and a biofilm to convert harmful PFAS into environmentally friendly byproducts. More specifically, the method involves H₂-induced defluorination of PFOA coupled to biodegradation of less fluorinated octanoic acid by microorganisms. In some aspects, the described method is a cost-effective method of defluorinating PFAS using a monometallic catalyst film, for example one comprising Pd.

The described method addresses the current deficiencies in commercial application of removing various fluorinated contaminants, such as PFOA and PFOS, from PFAS-contaminated water and wastewater. The method efficiently treats PFASs contaminated water and wastewater through reductively defluorination of PFASs to none- or less-fluorinated organic compounds, and then it uses biodegradation to completely mineralize them into H₂O, CO₂, and F⁻.

The disclosed method is suitable for long-term treatment of PFAS-contaminated water and wastewater as pilot- or full-scale systems. The synergy of the metal-catalytic and biodegradation processes makes the disclosed method of removing PFAS cost effective over methods of removing PFAS contaminants in the prior art. Operational input for the system is only hydrogen gas (H₂) and oxygen gas (O₂), which can be generated on-site, making it ideal for operation in remote locations.

### 1. Synergistic System for Removal and Mineralization of PFAS

In one embodiment, the system comprises a first reactor for H₂-induced defluorination of PFAS into less fluorinated counterparts of PFAS and a second reactor for O₂-induced biodegradation of the less fluorinated counterparts of PFAS. The first reactor catalytically reduces and defluorinated PFAS. The second reactor utilizes biological processes to metabolize the less fluorinated counterparts of PFAS into shorter chain PFAS and ultimately to CO₂. The first reactor is fluidly connected to the second reactor, wherein the effluent of the first reactor is the influent of the second reactor. In some aspects, the fluid flows at a hydraulic retention time (HRT) of no more than 24 hours. In certain implementations, the influent of the concentration of PFAS to the first reactor is less than 150 μM.

In certain nonlimiting embodiments, the system comprises at least one membrane, a hydrogen-gas source, and an oxygen-gas source. In some aspects, the first reactor (also referenced herein as the “catalytic reactor”) comprises a membrane and a hydrogen (H₂) gas source, while the second reactor (also referenced herein as the “biofilm reactor”) comprises a membrane and an oxygen (O₂) gas source. In certain implementations, the first reactor comprises a membrane, a monometallic catalyst film, and a H₂ gas source, while the second reactor comprises a membrane, a biofilm, and an O₂ gas source. The monometallic catalyst film and the biofilm are each deposed (for example, deposited or anchored) on the membrane of their respective reactor. Accordingly, the monometallic catalyst film is anchored or deposed on an H₂-delivering membrane, while the biofilm is deposed on an O₂-delivering membrane. In other words, the monometallic catalyst film is deposited on the liquid-phase side of the membrane of the first reactor, while the biofilm is anchored on the liquid-phase side of the membrane of the second reactor.

The monometallic catalyst film reduces and defluorinates PFAS and comprises precious metal nanoparticles with a diameter of less than 10 nm. In some aspects, the diameters of the precious metal nanoparticles are less than 5 nm, less than 3 nm, or less than 0.1 nm. In particular embodiments, the diameters of the nanoparticles are less than 0.1 nm and the nanoparticles form nanoclusters with diameters of 2-3 nm. In some aspects, the density of the precious metal nanoparticles in the catalyst film is between 0.2 to 4.5 g/m², for example, between 0.75 and 1.5 g/m², between 0.9 and 1.2 g/m², or about 0.9 g/m². In some embodiments, a 10-to-60-nm thick catalyst film is deposited on the liquid-phase side of the membrane of the first reactor. In some aspects, the catalyst film is 10 to 20 nm thick. In other aspects, the catalyst film is 40 to 60 nm thick. In certain embodiments, the monometallic catalyst film is made of nanoparticles of a platinum group metal. In some aspects, the monometallic catalyst film comprises palladium nanoparticles (PdNPs). Accordingly, in some aspects, the catalyst film is a Pd-film, which consists of monometallic palladium nanoparticles. To form the catalyst film, the H₂ gas in the first reactor functions as the electron donor to drive reduction of the soluble precious metals (with an oxidation state of +2 or +3) to elemental precious metals (with an oxidation state of 0), which spontaneously deposit as catalysts on the liquid-phase side of a membrane. In some aspects, the catalyst film is deposed directly on the liquid-phase side of the membrane.

The biofilm metabolizes the less fluorinated counterparts of PFAS and thus comprises heterotrophs capable of oxidizing partially fluorinated or non-fluorinated alkyl acids. The biofilm is also deposed on the liquid-phase side of a membrane. In some aspects, the biofilm is deposed directly on the liquid-phase side of the membrane. In some preferred embodiments, the defluorinated PFASs could be completely mineralized by biofilm anchored to a nonporous gas-delivering membrane. In other preferred embodiments, the biofilm needs extra carbon and energy sources to co-metabolically oxidize defluorinated PFASs.

In some implementations, for example, to establish a system for synergistic removal of PFAS, the system further comprises a catalyst-precursor medium, a microorganism-enrichment medium, and an inoculant comprising a biofilm-forming population of microorganisms. For example, the first reactor comprises a catalyst-precursor medium, while the second reactor comprises a microorganism-enrichment medium and an inoculant comprising a biofilm-forming population of microorganisms.

### a. Membrane

The membrane used in the first reactor and the second reactor typically do not have pores in its wall (e.g., a nonporous membrane). The lack of pores in the membrane enables transferring gas (e.g., hydrogen or oxygen) in a bubble-free form at controllable rates. In some embodiments, the membrane is a hollow-fiber membrane. In such embodiments, gas is supplied to the lumen of the hollow-fiber membrane (the gas-phase side). Accordingly, catalyst film or biofilm would be anchored to the outer surface of the hollow-fiber membrane (the liquid-phase side). In other embodiments, the membrane is a flat- or curled-sheet membrane. In such embodiments, gas (for example, hydrogen for the first reactor and oxygen for the second reactor) is supplied to one side of the sheet membrane (the gas-phase side), while catalyst film or biofilm anchored to the other surface of the sheet membrane (the liquid-phase side).

The membrane may be made of a variety of polymeric materials, for example polypropylene, polyurethane, polysulfone, or composite forms. In certain embodiments, the thickness of the membrane is may be 50 to 70 μm, for example between 50 and 55 μm.

In particular embodiments, the membrane is a nonporous polypropylene hollow-fiber membrane (200 μm OD, 100 to 110 μm ID, wall thickness 50 to 55 μm).

### b. Catalyst-Precursor Medium

The catalyst-precursor medium provides the soluble precious metals (with an oxidation state of +2 or +3) for the production of the catalyst film. The catalyst-precursor medium is monometallic and thus comprises one precious metal precursor. Accordingly, the precious metal is autocatalytic. For example, the precious metal is Au, Ag, Pt, Pd, Ru, or Rh. In some aspects, the catalyst-precursor medium comprises soluble platinum group metals. In certain embodiments, the precious metal precursor is any chemical that rapidly dissolve in the solvent and release soluble precious metal ions (for example, Ru³⁺ released from ruthenium chloride (RuCl₃)) or soluble precious metal complexes of various ligands (for example, (PdCl₄)²⁺ released from sodium tetrachloropalladate (Na₂PdCl₄)). In some aspects, the catalyst-precursor medium comprises one precious metal salt selected from a salt of Au, Ag, Pt, Pd, Ru, or Rh. Thus, in some embodiments, the monometallic catalyst-precursor medium contains either a Pd precursor or a Rh precursor. The precious metal concentration in the catalyst-precursor medium is 0.01 to 100 mM. In certain embodiments, the precious metal concentration range in the catalyst-precursor medium is 0.1 to 5 mM, for example, 4.5±0.5 mM, 4±1 mM, about 5 mM, or 5 nM. In some embodiments, the catalyst-precursor medium comprises acids (for example, hydrochloric acid), bases (for example, sodium hydroxide), and/or pH buffers (for example, potassium phosphate species) to adjust the pH to a desired value in the range of 4-10. In particular embodiments, the pH range of the catalyst-precursor medium is 6 to 8.

In some aspects, the catalyst-precursor medium comprises a liquid solvent. The liquid solvent may be water, salt solution, hydrochloric acid, methanol, ethanol, acetonitrile, toluene, dichloromethane, chloroform, or tetrahydrofuran. In certain embodiments, the liquid solvent is deionized water.

### c. Microorganism-Enrichment Medium

The microorganism-enrichment medium stimulates sufficient microbial growth to establish and/or maintain the biofilm. The microorganism-enrichment medium comprises at least one type of organic carbon source. The organic carbon source may be octanoic acid. In some embodiments, the medium comprises at least one carboxylic acid, for example acetate and/or propanoate. In certain aspects, the microorganism-enrichment medium comprises salts of a full spectrum of macronutrients, such as calcium (Ca), magnesium (Mg), phosphorus (P), sodium (Na), potassium (K), and iron (Fe). In some aspects, the growth medium also comprises salts of micronutrients, for example, zinc (Zn), manganese (Mn), boron (B), cobalt (Co), copper (Cu), nickel (Ni), molybdenum (Mo), and selenium (Se). In other embodiments, the growth medium comprises mixed phosphate salts (for example, H₃PO₄, NaH₂PO₄, Na₂HPO₄, and Na₃PO₄) as pH buffers.

### d. Inoculant

The inoculant comprises microorganisms capable of metabolizing less fluorinated counterparts of PFAS. The microorganisms in the inoculant form a biofilm that is anchored to the membrane. In particular embodiments, the inoculant comprises heterotrophic bacteria capable of oxidizing partially fluorinated or non-fluorinated alkyl acids. In some implementations, the inoculant is lake sediments, wetland sediments, or mixtures thereof. In other implementation, the inoculant comprises at least one pure strain, activated sludge collected from aerobic zones of wastewater treatment plants, landfill leachate, or their mixtures. Thus, in certain embodiments, the inoculant is aerobic sludge from a wastewater reclamation plant.

### e. H₂-Gas Source

The H₂-gas source can be any reliable source of H₂ gas for the first reactor, for examples, a gas storage tank having pressurized H₂ gas, a H₂ generator via water electrolysis, or a methane reformer. In some embodiments, the H₂ purity is over 99%. In other embodiments, the H₂-gas source include a built-in or external gas pressure regulator. The gas pressure regulator regulates the pressure of H₂ gas from the gas storage tank to the gas-phase side of the membrane in the first reactor.

### f. O₂-Gas Source

The O₂-gas source can be any reliable source of O₂ gas for the second reactor, for example, a gas storage tank having pressurized O₂ gas or air, an air pump, or an O₂-gas generator. In some embodiments, the O₂ purity is over 99%. In other embodiments, the O₂ source can be air (~21% O₂). The O₂-gas source includes a built-in or external gas pressure regulator. The gas pressure regulator regulates the pressure of O₂ gas from the O₂-gas source to the gas-phase side of the membrane in the second reactor.

### 2. Methods for Removal of PFAS

The method of removing PFAS in a fluid comprises reducing and defluorinating PFAS in an H₂-induced reaction catalyzed by precious metals, which produces a fluid comprising less fluorinated counterparts of PFAS; and mineralizing the less fluorinated counterparts of PFAS in an O₂-induced reaction mediated by microorganisms to produce a fluid comprising CO₂. The method may be regulated by altering reaction variables, which include, but are not limited to, adjusting the H₂ gas provided to the catalytic reactor, the pH of fluid comprising PFAS that is provided to the catalytic reactor, the concentration of PFAS in the fluid provided to the system and thus the catalytic reactor, or the hydraulic retention time (HRT) of the fluid provided to the system and thus the catalytic reactor.

In certain implementations, the method of removing PFAS in a fluid comprises contacting a fluid comprising PFAS with a monometallic catalyst film to produce a fluid comprising less fluorinated counterparts of PFAS, wherein the monometallic catalyst film comprises nanoparticles of a precious metal with diameters of less than 10 nm; and then contacting the fluid comprising less fluorinated counterparts of PFAS with a biofilm comprising microorganisms that metabolizes the less fluorinated counterparts of PFAS to produce a fluid comprising CO₂. In some implementations, the fluid comprising PFAS flows at a hydraulic retention time (HRT) of no more than 24 hours.

In some aspects, the method further comprises steps for establishing the monometallic catalyst film and the biofilm. The monometallic catalyst film is established in a first reactor, and the biofilm is established in a second reactor, wherein the catalyst film reduces and defluorinated PFAS and the biofilm metabolizes the less fluorinated counterparts of PFAS produced by the catalyst film. The precious metal catalysts spontaneously deposit on the nonporous H₂-delivery membrane as a catalyst film, while the microorganisms accumulate on the nonporous O₂-delivery membrane as a biofilm. Accordingly, in some aspects, the precious metal catalysts are deposed (for example, deposited) directly on a nonporous H₂-delivery membrane as catalyst film, while the microorganisms are deposed (for example, anchored) directly on a nonporous O₂-delivery membrane as biofilm. Thus, in certain embodiments, the first nonporous membrane is in a first reactor and the second nonporous membrane is in a second reactor. The second reactor is in fluid connection with the first reactor. In particular implementations, the fluid comprising PFAS flows at a HRT of no more than 24 hours.

The method of generating a catalyst film comprises providing an aqueous system comprising nonporous membrane; providing the system with catalyst-precursor medium to submerge the membrane into the solution of precious metal precursors; and pressurizing the gas-phase side of the membrane with H₂ at desired partial pressure. The H₂ gas donates electrons for the reduction of the soluble precious metals in the catalyst-precursor medium to elemental precious metals, which spontaneously deposit as catalysts on the membrane, particularly the liquid-phase side of the membrane. This coating of precious metal nanoparticles deposed on the membrane is the catalyst film, which is capable of reduction defluorination of PFAS.

In some aspects, the method of generating a catalyst film is a method of establishing the first reactor. In particular implementations, this method comprises contacting the liquid-phase side of the nonporous membrane with a catalyst-precursor medium. Meanwhile, the gas-phase side of the nonporous membrane is contacted with H₂ gas at a sufficient partial pressure to convert at least 90% of the precious metal salt in the catalyst-precursor medium to elemental form with a diameter of less than 5 nm.

In some implementations, the method of removing PFAS in a fluid further comprises providing a first nonporous membrane, wherein the first nonporous membrane comprises a gas-phase side and a liquid-phase side; contacting the liquid-phase side of the first nonporous membrane with a catalyst-precursor medium, the catalyst-precursor medium comprising a precious metal salt and a solvent; and contacting the gas-phase side of the first nonporous membrane with hydrogen (H₂) gas at a sufficient partial pressure to convert at least 90% of the precious metal salt in the precious metal medium to elemental form to establish the monometallic catalyst film. The elemental form of the precious metal is in the form of nanoparticles and is deposed on the liquid-phase side of the first nonporous membrane, which forms the monometallic catalyst film. In certain implementations, the precious metal concentration in the catalyst-precursor medium is 0.01-100 mM and the pH of the catalyst-precursor medium is 6 to 8. In some aspects, the precious metal is a platinum group metal, for example palladium.

In some aspects, at least 99% of the precious metal salt in the catalyst-precursor medium is converted to elemental form. In some aspects, the loading density of the catalyst film is between 0.2 to 4.5 g/m², for example, between 0.75 and 1.5 g/m², between 0.9 and 1.2 g/m², or about 0.9 g/m². In particular embodiments, the gas-phase side of the nonporous membrane is contacted with H₂ gas at a sufficient partial pressure to convert the precious metal salt in the catalyst-precursor medium to elemental form nanoparticles with diameters of less than 3 nm, less 2 nm, or less than 0.1 nm. In certain embodiments, the catalyst film comprises nanoclusters with diameters between 2 nm and 3 nm comprising nanoparticles with diameters of less than 0.1 nm.

In a particular embodiment, the method of establishing a catalyst film for reductive defluorination of PFAS in a fluid comprises providing a nonporous membrane, wherein the nonporous membrane comprises a gas-phase side and a liquid-phase side; contacting the liquid-phase side of the nonporous membrane with a catalyst-precursor medium comprising a palladium salt and a solvent; and contacting the gas-phase side of the nonporous membrane with hydrogen (H₂) gas at a sufficient partial pressure to convert at least 90% of the palladium salt in the precious metal medium to elemental form. The concentration of palladium in the catalyst-precursor medium is 0.1 to 100 mM. The elemental form of palladium is in the form of nanoparticles with a diameter of less than 0.1 nm and nanoclusters with diameters of less than 5 nm. The nanoparticles and nanoclusters are deposed (for example, deposited) on the liquid-phase side of the nonporous membrane to form the monometallic catalyst film.

The method of generating a biofilm is a method of establishing the second reactor. This method comprises submerging a nonporous membrane with a microorganism-enrichment medium; contacting an inoculant with the nonporous membrane; and pressurizing the gas-phase side of the membrane with O₂ at desired partial pressure. The second reactor is continuously or repeatedly feed with the microorganism-enrichment medium. In some embodiments, the microorganism-enrichment medium is provided to the inoculated aqueous system at a HRT of 0.1-48 hours. In some embodiment, the HRT is between 4 and 20 hours, for example, 12 hours. In other embodiments, the system is continuously fed with the microorganism-enrichment medium for 2 and 24 weeks, for example, one month.

In some implementations, the method of removing PFAS in a fluid further comprises submerging a second nonporous membrane with a microorganism-enrichment medium comprising an organic carbon source; contacting an inoculant with the second nonporous membrane, wherein the inoculant comprises heterotrophs capable of oxidizing partially fluorinated or non-fluorinated alkyl acids; and pressurizing the gas-phase side of the second nonporous membrane with oxygen (O₂) gas at desired partial pressure, whereby a biofilm that metabolizes the less fluorinated counterparts of PFAS is formed on the liquid-phase side of the second nonporous membrane. In some aspects, the microorganism-enrichment medium further comprises salts of macronutrients, salts of micronutrients, and/or phosphate salts.

In certain aspects, a method of producing a synergistic system for PFAS removal from a fluid is disclosed. The method comprises producing a monometallic catalyst film that reduces PFAS to produce less fluorinated counterparts of PFAS and producing a biofilm that metabolizes the less fluorinated counterparts of PFAS. The method comprises providing a first nonporous membrane, the first nonporous membrane comprising a gas-phase side and a liquid-phase side; contacting the liquid-phase side of the first nonporous membrane with a catalyst-precursor medium, the catalyst-precursor medium comprising a precious metal salt and a solvent; and contacting the gas-phase side of the first nonporous membrane with hydrogen (H₂) gas at a sufficient partial pressure to convert at least 90% of the precious metal salt in the precious metal medium to elemental form to form a monometallic catalyst film. The elemental form of the precious metal is in the form of nanoparticles with diameters of less than 10 nm, and the precious metal nanoparticles are deposited on the liquid-phase side of the first nonporous membrane.

The method of producing a synergistic system for PFAS removal from a fluid further comprises providing a second nonporous membrane, wherein the second nonporous membrane comprises a gas-phase side and a liquid-phase side; submerging the second nonporous membrane with a microorganism-enrichment medium comprising an organic carbon source; contacting an inoculant with the liquid-phase side of the second nonporous membrane; and pressurizing the gas-phase side of the second nonporous membrane with oxygen (O₂) gas at desired partial pressure thereby forming a biofilm on the liquid-phase side of the second nonporous membrane. The inoculant comprises heterotrophs capable of oxidizing partially fluorinated or non-fluorinated alkyl acids. In some embodiments, the first nonporous membrane is in a first reactor, the second nonporous membrane is in a second reactor, and the first reactor and the second reactor are in fluid connection. In certain embodiments, the precious metal is a platinum group metal, for example palladium.

### Illustrative, Non-Limiting Examples in Accordance with Certain Embodiments

The disclosure is further illustrated by the following examples that should not be construed as limiting. The contents of all references, patents, and published patent applications cited throughout this application, as well as the figures, are incorporated herein by reference in their entirety for all purposes.

### 1. Adsorption and Reductive Defluorination of Perfluorooctanoic Acid (PFOA) Over Palladium Nanoparticles

This example tested the hypothesis that PFOA can be efficiently destroyed via reductive defluorination over Pd⁰ catalysts. Similar to other hydrodehalogenating processes, PFOA was adsorbed on the Pd⁰ surface, and the F in each C—F bond was replaced by an adjacent activated H atom (H_{ads}*), which also was adsorbed on the Pd⁰ surface via H₂ dissociation. A bench-scale membrane catalyst-film reactor (MCfR) was used to examine PFOA removal and defluorination. The MCfR enabled reliable and controllable supply of H₂ in the bubble-free form through nonporous membranes, onto which Pd⁰ nanoparticles were spontaneously synthesized and deposited at ambient temperature with high stability and longevity. In particular, the roles of PFOA adsorption and H₂-driven defluorination were studied using relatively high concentrations of PFOA removal in the batch-mode MCfRs. Long-term continuous removal of PFOA at environmentally relevant concentrations in a continuously operated MCfR were also evaluated.

### a. Materials and Methods

i. Reactor Setup

The bench-scale MCfR configuration comprised a 30-cm glass tube connected with plastic tubing through a recirculation pump (Masterflex, USA) that gave a recirculation rate of 150 mL/min and made the MCfR's liquid contents well-mixed. The tube had a bundle of 120 24-cm hollow-fiber membranes (polypropylene; Teijin, Ltd., Japan) with 200-μm OD, 100 μm ID, and wall thickness at 50 μm. It contained 181 cm² of the total membrane surface area and a 40-mL working volume.

ii. In Situ Synthesis and Deposition of Pd⁰ Catalysts on the Membranes

The Pd²⁺ precursor solution contained 5 mM sodium tetrachloropalladate (Na₂PdCl₄) dissolved in deoxygenated deionized water (DI) at pH 7.0 controlled using a potassium phosphate buffer. The MCfR was filled with the precursor solution and then kept the MCfR in batch mode (i.e., no influent or effluent) for 24 hours until the <1% of Pd (II) was left in the liquid phase. This yielded 0.016 g of Pd⁰ loaded on the membrane surface, giving an average surface density of 0.9 g/m². The liquid was drained from the MCfR and rinsed the MCfR with DI water 3 times.

iii. Batch Tests of Catalytic Defluorination of PFOA Using MCfR Under Recirculating Flow

Two freshly prepared MCfRs and one reactor with bare membranes as a control were set up. One of the MCfRs was supplied with N₂ and the other was supplied with H₂ to test the removal of PFOA by adsorption alone (N₂) and by adsorption plus defluorination (H₂). Two more MCfRs were set up with H₂ and another with N₂; they were fed with 100 μM PFOA for 3 sequential batch cycles.

To begin each batch test, the MCfR or control was purged with pure N₂ gas for 15 mins to remove O₂, and then the PFOA stock solution was rapidly (~10 sec) introduced into the MCfR using the feeding pump. The batch test began once the MCfR or control was filled with the PFOA stock solution.

iv. Single-Pass Flow Tests of Catalytic Defluorination of PFOA Using MCfR

Two freshly produced H₂-MCfRs were set up, each having 0.9 g Pd⁰/m², for continuous removal of ~500 ng/L PFOA supplied with constant N₂ pressure of 20 psig (adsorption alone) or constant H₂ pressure of 20 psig (adsorption and defluorination). The continuous flow rate was 0.025 ml/min, which yielded a hydraulic retention time (HRT) of 24 hours and a PFOA surface loading of 0.8 g/m²/day.

v. Nanoparticle Collection and Solid-State Characterization

After the batch test, several pieces of membrane were cut from the MCfR and the samples were prepared based on established protocol (Zhou et. al., “Coupling of Pd nanoparticles and denitrifying biofilm promotes H₂-based nitrate removal with greater selectivity towards N₂.” Appl. Catal. B 2017, 206: 461-470). After fixation, these sample were examined using JEM-ARM200F scanning transmission electron microscopy (STEM) for imaging, crystallite diffraction, and lattice-fringe fingerprinting. X-ray photoelectron spectroscopy of the fibers was carried out using a PHI Quantera SXM (ULVAC-PHI. Inc) with an Al source (the focused beam of 1.5 kV, 25 W). X-ray powder diffraction (XRD) was conducted with a Philips X'Pert Pro equipped with a Cu Kα radiation source (1.540598 Angstrom). XRD analysis was conducted in a 2theta range of 10-90 degree, with a step size of 0.0050 s⁻¹.

vi. Sampling and Analyses

Liquid samples were collected from the MCfR using 3-mL syringes and immediately filtered the sample through a 0.22-μm PES membrane filters (NEST Scientific). F⁻ was analyzed using an ion chromatograph (IC-930, Metrohm, USA). PFOA (>0.1 μM, 0.04 ppm) was determined using ultra-performance liquid chromatography (UPLC) (WATERS LC-20A, United States) with a Waters C18 column and an evaporative light scattering detector (ELSD). PFOA (at the ppt level) was determined using an Agilent 1290 UPLC coupled to 6490 triple quadrupole mass spectrometer system (QQQ-MS) based on the EPA Method 537.1. Defluorination products from PFOA were analyzed using an Agilent 1290 high performance liquid chromatography coupled to the Agilent 6530 quadrupole/time-of-flight mass spectrometer (HPLC-QTOF-MS). Details of the analytical methods, including detection limits, are summarized in Section 1 of the SI.

vii. Calculations

PFOA removal ratio was calculated through Eq. (1):

$$PFOA removal ratio = \frac{{C}_{0} - {C}_{PFOA}}{{C}_{0}} \qquad ( 1 )$$

where C₀ is the initial PFOA concentration and C_{PFOA} is the PFOA concentration (μM).

Defluorination ratio was calculated through Eq. (2):

$$Defluorination ratio = \frac{{C}_{F}}{15 ( {C}_{0} - {C}_{PFOA} )} \qquad ( 2 )$$

where C_{F} is the fluoride ion concentration (μM).

PFOA surface loading was calculated through Eq. (3):

$$Surface loading = {C}_{0} \frac{Q}{A} \qquad ( 3 )$$

where surface loading is in the unit of μg/m²/day; C is the concentration of influent PFOA (μg/L); Q is the flow rate (L/day); and A is the total fiber surface area (18.48×10⁻³ m²). Removal flux was calculated through Eq. (4):

$${J}_{pfoa} = ( {C}_{0} - {C}_{PFOA} ) \frac{Q}{A} \qquad ( 4 )$$

where J_{pfoa} is the removal flux for reducing PFOA (μg/m²/day).
viii. Computational Methods

Density Functional Theory (DFT) calculations was performed to determine the PFOA adsorption modes on the most stable Pd (111) surface and to investigate the effect of surface hydrogen coverage on PFOA adsorption. On the Pd (111) surface, the adsorption energy of the PFOA molecule was calculated as

$$Δ {E}_{Pd / PFOA}^{ads} = {E}_{Pd / PFOA} - {E}_{Pd} - {E}_{PFOA} \qquad ( 5 )$$

where E_{Pd/PFOA} is the energy of PFOA adsorbed on Pd (111), E_{Pd} is the energy of the clean Pd (111) slab, and E_{PFOA} is the energy of the isolated PFOA molecule. DFT calculations were performed with the Vienna ab initio simulation package (VASP 5.4.4) in conjunction with the VASPsol implicit solvation model.
ix. DFT Computational Methods

The Perdew-Burke-Ernzerhof (PBE) was employed to generalize gradient approximation of the exchange-correlation functional within the projector augmented wave (PAW) formalism. The valence electrons of Pd (4d¹⁰), C (2s²2p²), F (2s²2p⁵), O (2s²2p⁴), and H (1s¹) were treated self-consistently, and all the calculations were spin polarized. A kinetic energy cutoff of 450 eV was used for the plane-wave basis sets and a Monkhorst-Pack k-point mesh of 2×2×1 was used for sampling the Brillouin zone. The Methfessel-Paxton smearing method with a smearing width of 0.2 eV was used to integrate the Brillouin zone. Grimme's DFT-D3 dispersion correction was applied to include the van der Waals interactions. All the self-consistent electronic optimizations were converged to within 0.01 meV, and all the geometry optimizations were converged to forces within 0.02 eV Å⁻¹.

The most stable Pd (111) surface was employed for the PFOA adsorption calculations. A 6×6 slab model consisted of four layers of Pd atoms, where the bottommost layer was frozen to represent the bulk. Each layer was comprised of 36 Pd atoms, and periodic boundary conditions were applied in all three directions. An implicit electrolyte region of 28 Å was employed in the direction perpendicular to the Pd surface to include the solvation effects and to avoid the spurious interactions between the periodic cell images. Default VASPsol parameters were used for the implicit solvation model, except for the effective surface tension (τ) parameter, which was set to zero to avoid instabilities in the local electrostatic potential in the electrolyte region. The cell containing the deprotonated form of PFOA was negatively charged to treat PFOA as an anion, which required the addition of a QV correction term in the potential energy of the system with Q being the charge of the simulation cell and V being the local electrostatic potential in the electrolyte region. The overall cell charge was balanced through implicit counter-ions introduced by the VASPsol solvation model, as described by Hennig and co-workers.

x. Characteristics of Pd⁰ Loaded on Membranes

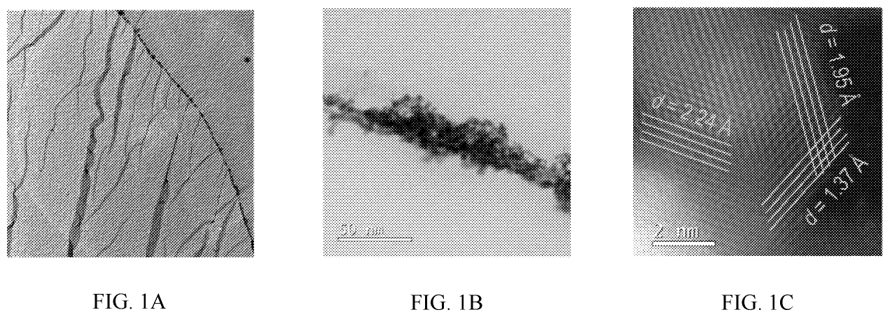

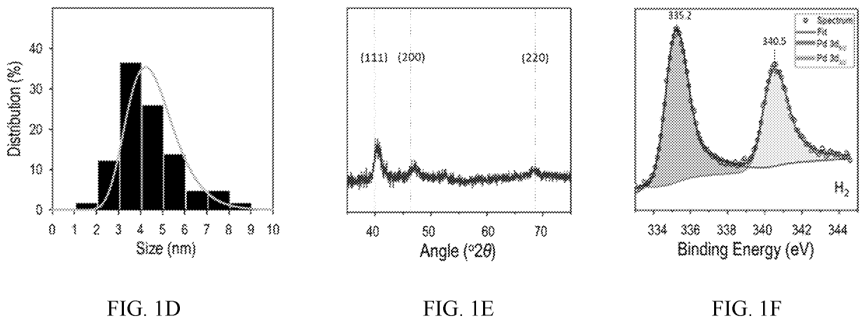

FIGS. 1A-1F present the solid-state characteristics of the fiber samples loaded with 0.9 g/m² Pd⁰ in the MCfR. The TEM images (FIG. 1A) reveal that black precipitates were anchored onto the membrane surface firmly and evenly as a continuous film: The film was 10-20 nm thick and composed of stacked nanoparticles (FIG. 1B) featuring lattice spacings of 1.37, 1.95, and 2.24 Å (FIG. 1C) corresponding to the (220), (200), and (111) planes of typical face-centered cubic (FCC) Pd⁰. These Pd⁰NPs had an average size of 4.2 nm (FIG. 1D), which is similar to those in previous MCfR studies. The XRD pattern further verified the presence of crystalline Pd⁰, with three characteristic diffraction peaks at 40.4°, 47.0° and 68.4°, with d-spacing values of 1.37, 1.93, and 2.23 corresponding to (111), (200), and (220) planes, respectively, similar values obtained by the lattice spaces on micrograph from FIG. 1C. The crystallite size of 5.9 nm was estimated using Scherrer equation. XPS analysis (FIG. 1F) reveals only the existence of one peak at Pd_{3/2} and Pd_{5/2} energy, centered at 340.5 eV and 335.3 eV, which indicates the presence of only Pd⁰.

### b. Chromatographic Methods

xi. UPLC-QQQ-MS

The LC-MS/MS method used herein to measure PFOA is based on EPA Method 537. All LC-MS/MS experiments were performed on an Agilent 1290 UPLC-6490 QQQ-MS system. Targeted data acquisition was performed in the multiple-reaction-monitoring (MRM) mode, due to its significant advantages in selectivity and quantitation. Samples were run with a set of internal or external standards for determining absolute concentrations of PFOA. A set of quality control (QC) samples were prepared and measured once every 10 study samples.

xii. HPLC-QTOF-MS

PFOA and its products were measured on an Agilent 1290 HPLC coupled to the Agilent 6530 quadrupole/time-of-flight mass spectrometer system using electrospray ionization in negative mode (ESI−) for TOFMS mode. Precursor-ion data were collected for m/z 100-1200 for 1283 cycles with a total scan time of 842 ms and accumulation time of 20 ms, ion spray voltage set at −4500 V, and temperature set to 550° C. The ion source, curtain, and collision (CAD) gas are set to 60 psig, 35 psig, and 10 psig, respectively. The collision energy was set to −5 V and the declustering potential to −20 V, both with no spread. Product-ion scanning was conducted for m/z 50-1200 Da. The accumulation time for each SWATH window was 50 ms, and the collision energy was −35 V with 30 V spread. The instrument was mass calibrated using SCIEX ESI Negative Calibration Solution.

xiii. UPLC

PFOA was determined by Ultra Performance Liquid Chromatography (UPLC) (WATERS LC-20A, United States) using a Waters C18 column and an Evaporative light scattering detector (ELSD). The flow rate of the UPLC pump was 0.3 ml/min. Mobile phase B was methanol with 2 mM ammonium acetate, and mobile phase A was methanol and ultrapure water at the proportion of 5/95 with 2 mM ammonium acetate.

xiv. IC

The F⁻ concentration was analyzed using an ion chromatograph (IC-930, Metrohm, USA) with a C18 column. The flow rate was 0.7 ml/min. The eluents were 3.2 mM sodium carbonate (Na₂CO₃) and 1 mM sodium bicarbonate (NaHCO₃).

xv. Detection Limits

| Instrument | Compounds | Limits of detection (LODs) | |
|---|---|---|---|
| HPLC-MS-MS | PFOA | <10 | ng/L |
| UPLC | PFOA | 0.1 | μM |
| IC | F⁻ | 0.2 | μM |

### c. Batch Tests of PFOA Removal Over Pd⁰: Adsorption and Defluorination Mechanisms

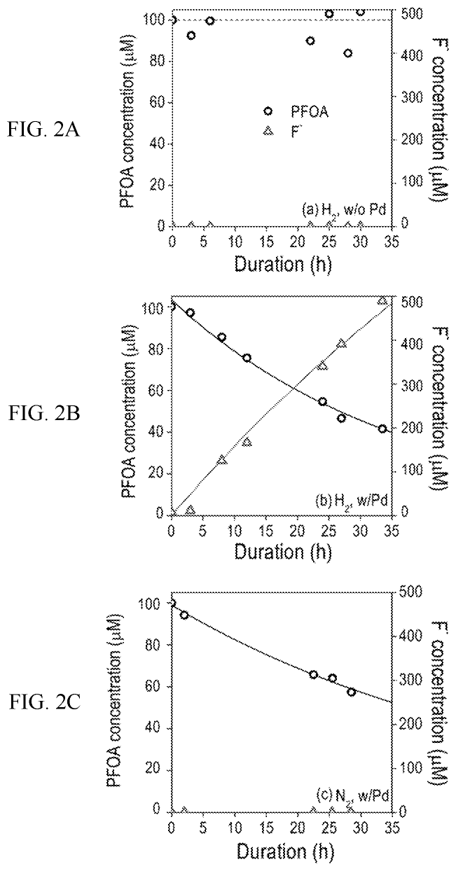

FIGS. 2A-4 show the experimental results for the batch tests of PFOA depletion in the MCfRs. The default conditions included 0.9 g/m² Pd⁰, 0.1 mM initial PFOA, pH 4, and constant 20 psig (2.36 atm absolute) gas pressure.

xvi. Pd⁰-Catalyzed Reductive Defluorination of PFOA in the Presence of H₂

In the absence of Pd⁰ (i.e., bare membranes with H₂ supply; FIG. 2A), the PFOA concentration did not change over 35 hours (FIG. 2A), indicating that PFOA did not react with the polypropylene membranes or other materials in the MCfR. With 0.9 g/m² Pd⁰NPs loaded on the membrane surface and the same H₂ supply, 58% of the PFOA was depleted within 35 hours (FIG. 2B), along with gradual release of free fluoride ions (F⁻) up to 0.49 mM (accounting for 55% of all F in the depleted PFOA).

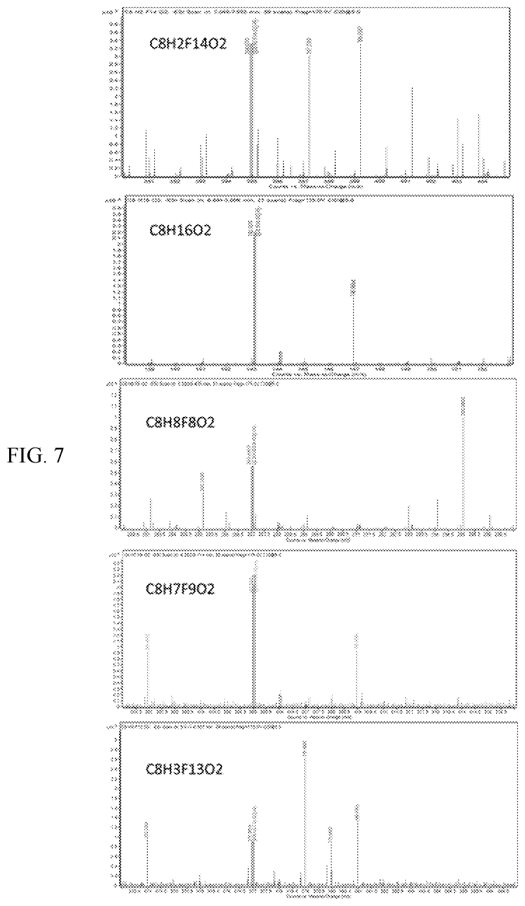

HPLC-QTOF-MS analyses (FIG. 7) further reveal that, while PFOA (C₈HO₂F₁₅) was the only fluorinated carboxylic acid (CₐH_{b}O₂F_{d}) detected initially, at least four partially fluorinated octanoic acid (OA) species (C₈H₂F₁₄O₂, C₈H₃F₁₃O₂, C₈H₇F₉O₂, and C₈H₈F₈O₂) and non-fluorinated OA (C₈H₁₆O₂) were identified in the bulk liquid of the H₂-MCfR after 35 hours.

These results verify our hypothesis and document for the first time that Pd⁰ is capable of catalyzing reductive defluorination of PFOA into partial or non-fluorinated OAs. The HPLC-QTOF-MS results suggest the following reactions occurred:

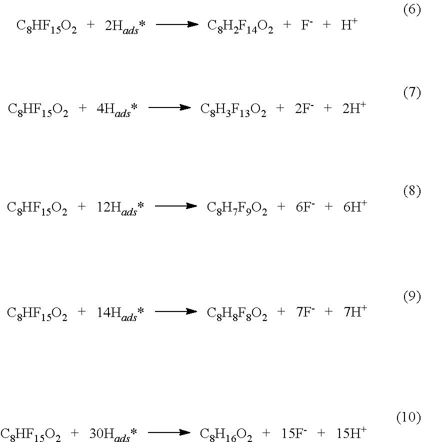

xvii. Non-Defluorinative Adsorption of PFOA on Pd⁰ in the Absence of H₂.

When H₂ was replaced by N₂ at the same pressure of 20 psig, PFOA removal was detected at 41%, but no F⁻ release was detected within 30 hours (FIG. 2C). No partially defluorinated carboxylic acids were detected by HPLC-QTOF-MS. These results reveal that, in the absence of H₂ as the electron donor, no defluorination or other chemical reactions occurred, but the H_{ads}*-free Pd⁰ still was able to adsorb PFOA.

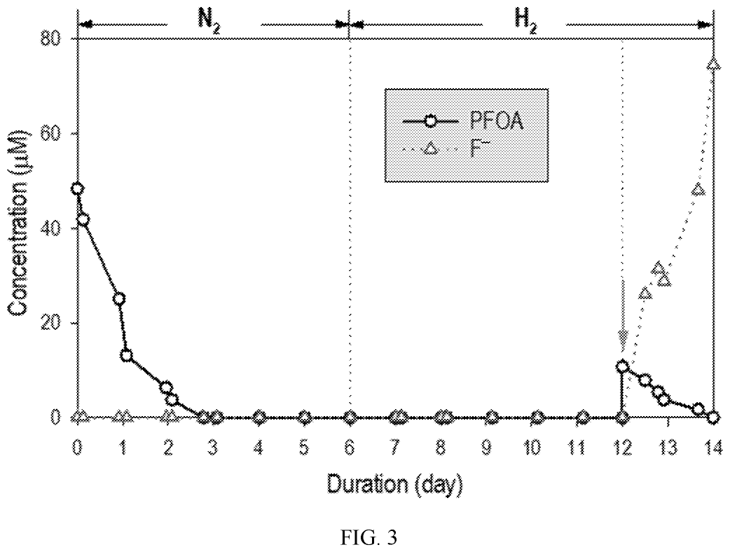

To explore further this observation of PFOA adsorption on H_{ads}*-free Pd, an extended two-week batch test (FIG. 3) was carried out. Over 99.9% of the initial 0.05 mM PFOA was adsorbed by the Pd⁰ within 67 hours under N₂. After 6 days, N₂ was replaced with H₂, but F⁻ release was not observed for the following 6 days. This suggests that the adsorbed PFOA on the H_{ads}*-free Pd⁰ surface was not able to be defluorinated in the presence of H₂. The system was then re-spiked 0.01 mM PFOA, and >99% PFOA removal along with 46% defluorination was observed within 50 hours. This implied that Pd⁰ still had active sites available for H_{ads}*, and the H_{ads}* was able to defluorinate newly introduced PFOA from the bulk liquid, but not PFOA already adsorbed prior to the presence of H_{ads}*.

xviii. Mechanistic Interpretation of the Batch Results

Overall, the batch results identify two distinct adsorption patterns involved in PFOA removal by Pd⁰: H_{ads}*-independent non-reactive adsorption and H_{ads}*-dependent reactive (defluorinating) adsorption. The two adsorption patterns are associated not only with H_{ads}*, but also with different adsorptive positions and orientations.

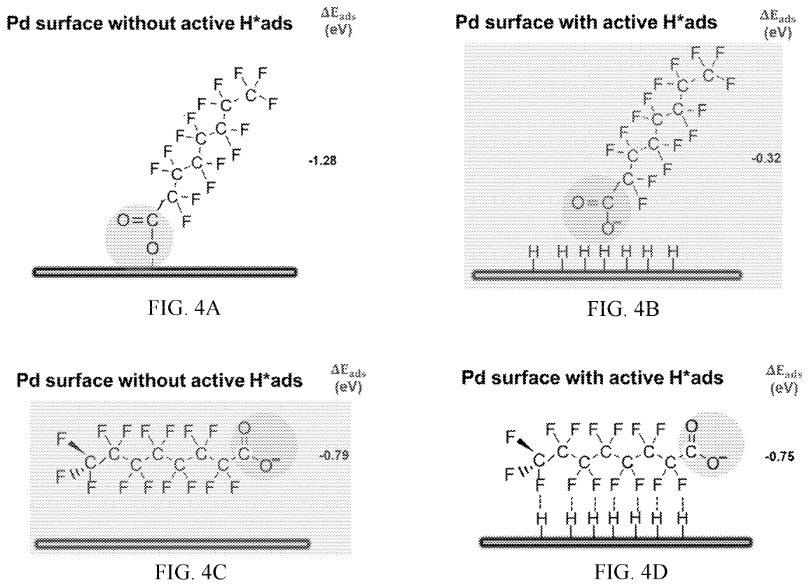

The hypothesis of different adsorption orientations is based on DFT modeling, whose results are summarized in FIGS. 4A-4D. Because reported pKₐ values for PFOA are ≤2.8, PFOA predominantly exists in the deprotonated form as the C₇F₁₅COO⁻ anion. DFT calculations reveal that, when H₂ is absent (FIGS. 4A and 4C), C₇F₁₅COO⁻ tends to bind to active Pd⁰ sites in a perpendicular orientation, because of its more favorable adsorption energy

$$( Δ {E}_{Pd / PFOA}^{ads} = - 1.28 eV )$$

when a metal-oxygen bond can form compared to a parallel orientation

$$( Δ {E}_{Pd / PFOA}^{ads} = - 0.79 eV ) ,$$

characteristic of physisorption. The non-reactive adsorption occurs through the carboxylate head group of PFOA binding via chemisorption by the formation of a Pd—O complex. The tail group is oriented off the surface, which keeps C—F bonds away from the Pd surface and thus minimizes chances of contact-based hydrodefluorination even when H_{ads}* is introduced.

In contrast, when H₂ is present (FIGS. 4B and 4D), the high amounts of H_{ads}* on the surface block Pd—O bond formation, which favors parallel binding orientation

$$( Δ {E}_{Pd / PFOA}^{ads} = - 0.75 eV ,$$

compared to −0.32 eV for the perpendicular orientation) through van der Waals attraction. Parallel adsorption allows maximum contact of C—F bonds and H_{ads}* on Pd⁰ surface, which promotes catalytic reduction of PFOA via surface H addition or F/H substitution. After the reaction, defluorinated products and fluoride desorb from Pd surface, which frees Pd⁰ active sites for continued defluorinative adsorption of PFOA. This DFT-based atomistic-scale insight into PFOA adsorption on the Pd⁰ surface agrees with the adsorption trends observed experimentally.

### d. Long-Term Tests on PFOA Removal Over Pd⁰: Efficiency and Longevity

xix. Sequential Batch Tests

FIGS. 5A-1-5D shows the experimental results for three successive cycles of batch tests in which 100 μM PFOA was applied in each cycle to each of the two MCfRs loaded with 0.9 g/m² Pd⁰ but supplied with different gases. In the N₂-MCfR (FIGS. 5A-1, 5A-2, and 5A-3), 41% of the PFOA was steadily depleted within 45 h in Cycle 1, but PFOA removal slowed and even stopped after 10 hours in Cycle 2 and was negligible in Cycle 3; this shows that the Pd⁰ surface had become saturated with PFOA adsorbed on non-reactive sites by Cycle 2.

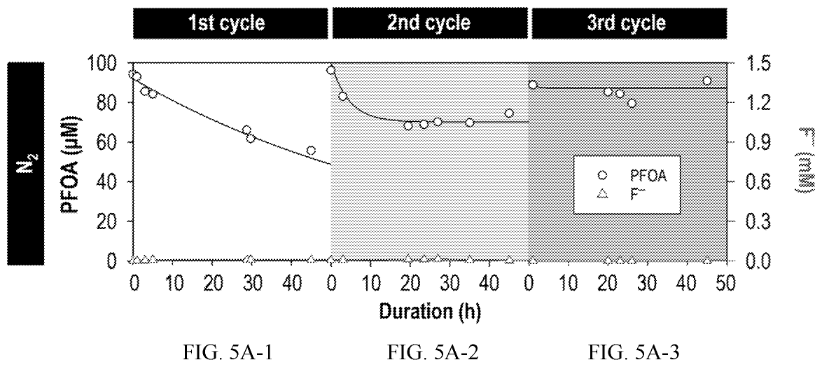

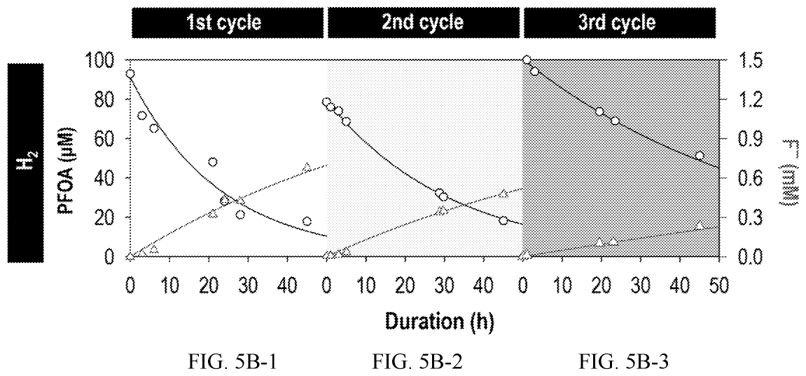

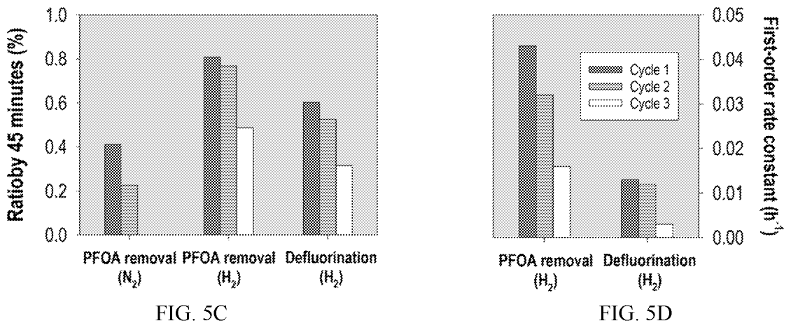

When H₂ was supplied (FIGS. 5B-1, 5B-2, and 5B-3), over 80% of the applied PFOA was depleted within 45 h in Cycle 1, along with 0.6 mM F⁻ release (58% defluorination ratio). In the following two cycles, PFOA still was depleted, although the removal ratios decreased to 75% and 47%, along with decreased defluorination ratios of 52% and 31%, respectively (FIG. 5C). On the one hand, the results reinforce that PFOA in the H₂-MCfR was mainly removed through defluorinative adsorption that led to the desorption of F⁻ and defluorinated products,^{25, 49} which freed the active site with H_{ads}* for further reductive defluorination of PFOA from the bulk liquid. On the other hand, the gradual slowing of PFOA removal and defluorination rates (FIG. 5D) suggests that active sites were becoming deactivated, probably due to the co-occurrence of non-defluorinative adsorption along with the defluorinative adsorption of PFOA. In order to maintain defluorinative activities for persistent PFOA depletion, non-defluorinative adsorption of PFOA needs to be minimized.

### xx. 70-Day Continuous Tests

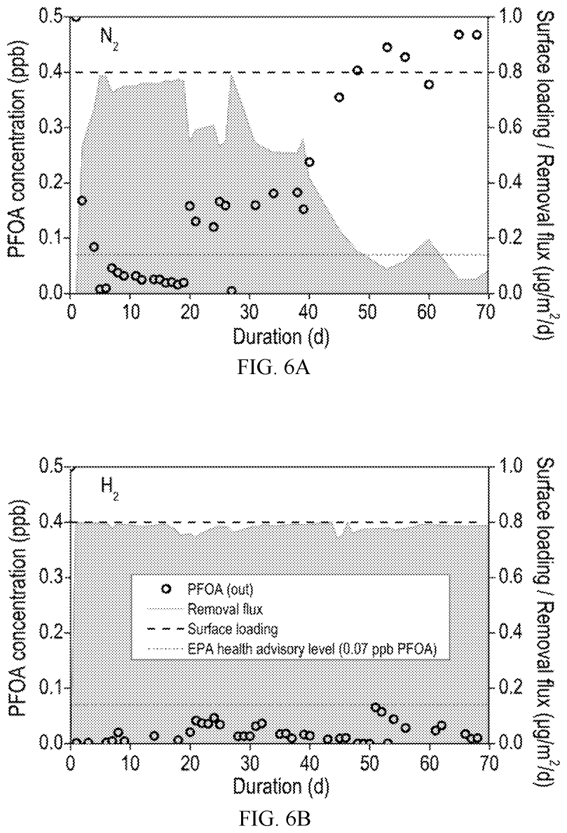

FIGS. 6A and 6B show PFOA removals in two MCfRs operated in parallel with continuous flow over 70 days, but with either N₂ (FIG. 6A) or H₂ (FIG. 6B) delivered to the membranes. Both MCfRs were continuously fed with ~500 ppt PFOA at the same flow rate of 0.025 mL/min (or an HRT of 24 hours). The default conditions included 0.9 g/m² Pd⁰ and constant 20 psig (or 2.36 atm absolute) gas pressure.

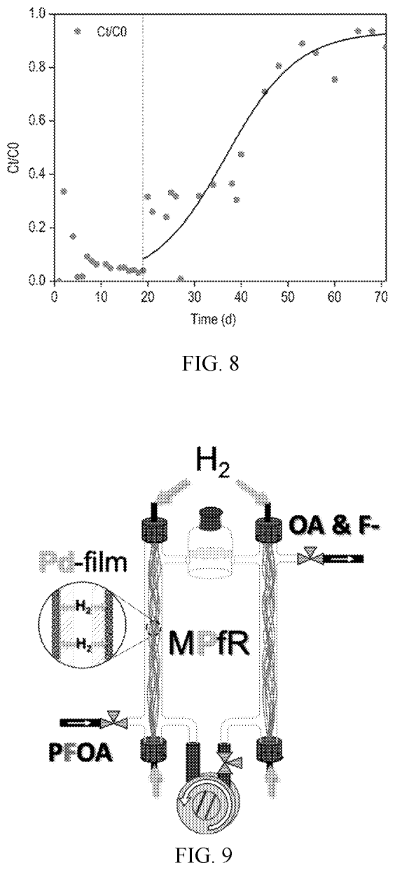

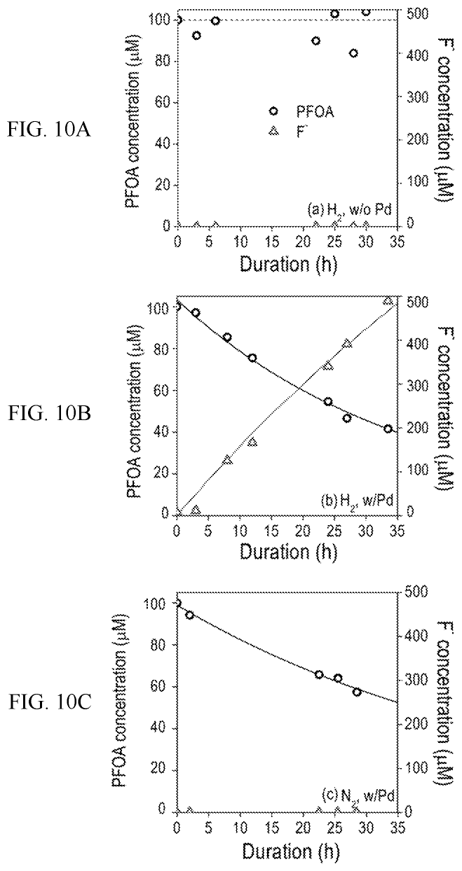

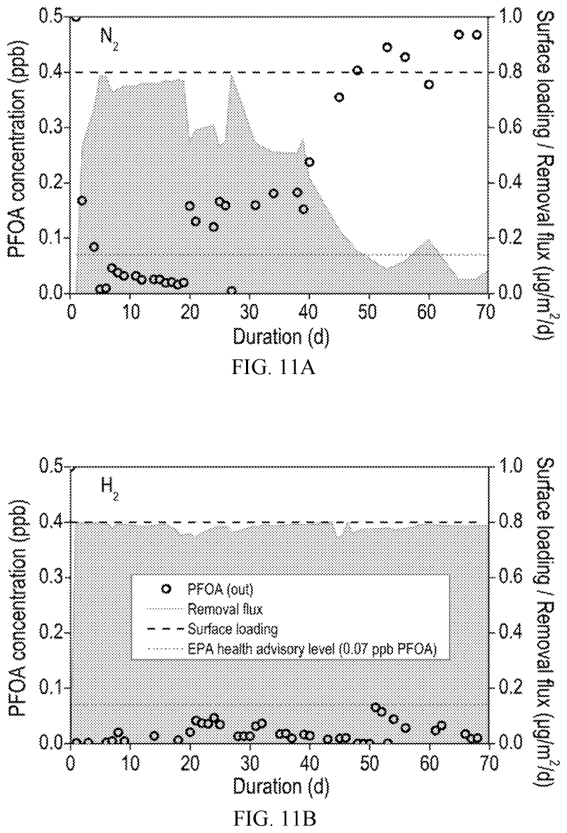

In the N₂-MCfR (FIG. 6A), it took more than 5 days to achieve 99% of PFOA removal, and the effluent concentration of PFOA remained lower than the EPA health advisory level (70 ng/L) for the following 15 days. After 15 days, however, the effluent concentration of PFOA began to gradually increase and eventually was close the influent concentration after day 45. This trend is similar to the results with the sequential-batch tests (FIGS. 5A-1, 5A-2, and 5A-3) and confirms that, without H₂, exclusively non-defluorinative adsorption of PFOA on the Pd⁰ surface became saturated. According to the breakthrough curve (FIG. 8), the total PFOA being adsorbed was 0.59 μg in 70 days.

The H₂-MCfR achieved 99% PFOA removal within 1 day, and the effluent PFOA concentrations were consistently 20±16 μg/L (i.e., less than a third of the EPA's health advisory level) throughout the 70 days of continuous operation. The minimal deactivation of the Pd⁰ catalyst suggest that accumulation of non-reactively adsorbed PFOA was not important due to the constantly low concentration of PFOA in the MCfR.

### e. Environmental Implications

This study is the first report of Pd⁰-catalyzed defluorination of perfluorinated compounds. Fast adsorption of PFOA and the release of F⁻ and partially and fully defluorinated compounds verified that the H₂-MCfR catalytically removed and destroyed PFOA. Defluorination preceded by PFOA adsorption in a parallel orientation that enabled reaction between F substituents on PFOA and activated H on the Pd⁰ surface. Operating under continuous flow, the MCfR was capable of sustained removal of PFOA at environmentally relevant concentrations, averaging 97% removal to well below 70 ng/L for more than two months.

The success lies in efficient H₂ delivery in the MCfR. In the conventional heterogeneous supported Pd catalysts with H₂ in the headspace, non-reactive adsorption of PFOA occurs quickly and may hinder the slower H₂ mass transfer from the liquid phase to the catalyst surface, leading to no defluorination. In contrast, the nonporous membrane in the MCfR circumvents this mass transfer limitation by allowing counter-diffusion of bubble-free H₂; In consequence, H* was in excess at the surface of Pd⁰, which blocks the vertical non-defluorinative adsorption and promotes defluorination via parallel adsorption.

In the MCfR, PFOA can be defluorinated to less- or non-fluorinated octanoic acids in the presence of H₂ as the electron donor:

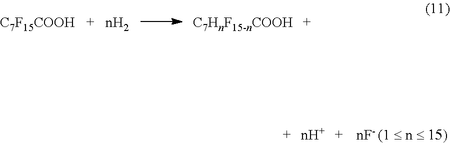

Partially or fully defluorinated counterparts are more bioavailable and can be further biodegraded by aerobic bacteria, possibly yielding complete mineralization to CO₂:

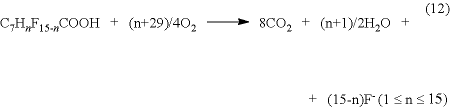

Therefore, catalytic defluorination using the MCfR platform opens a door for efficient and thorough treatment of PFAS-contaminated water when it used synergistically with biodegradation.

### 2. Biodegradation of Less Fluorinated PFAS: An Example of Partially Fluorinated OA Removal in the O₂-Based Membrane Biofilm Reactor (O₂-MBfR)

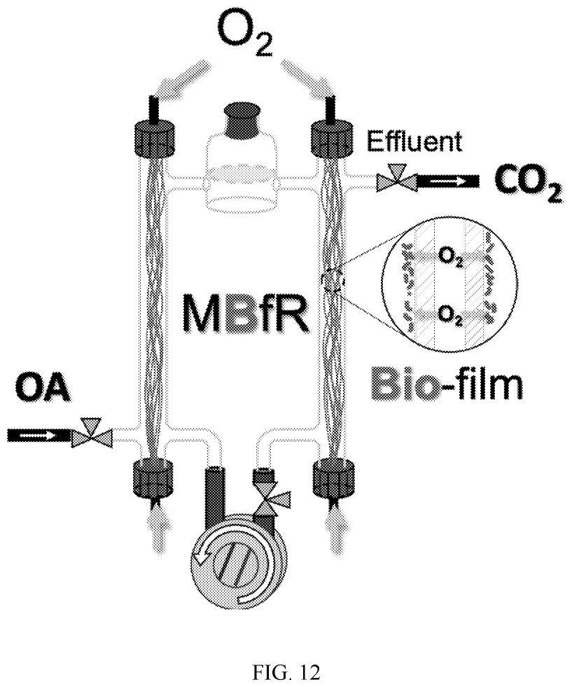

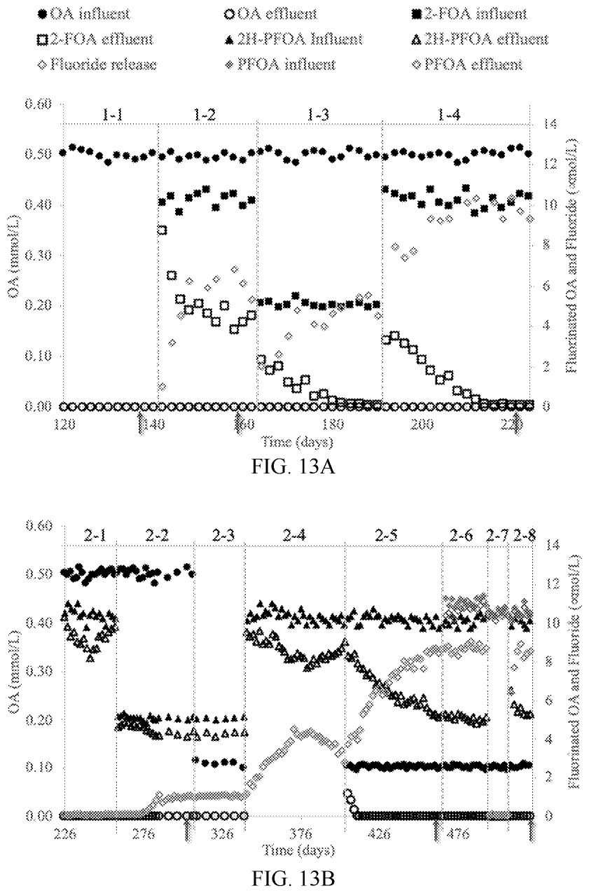

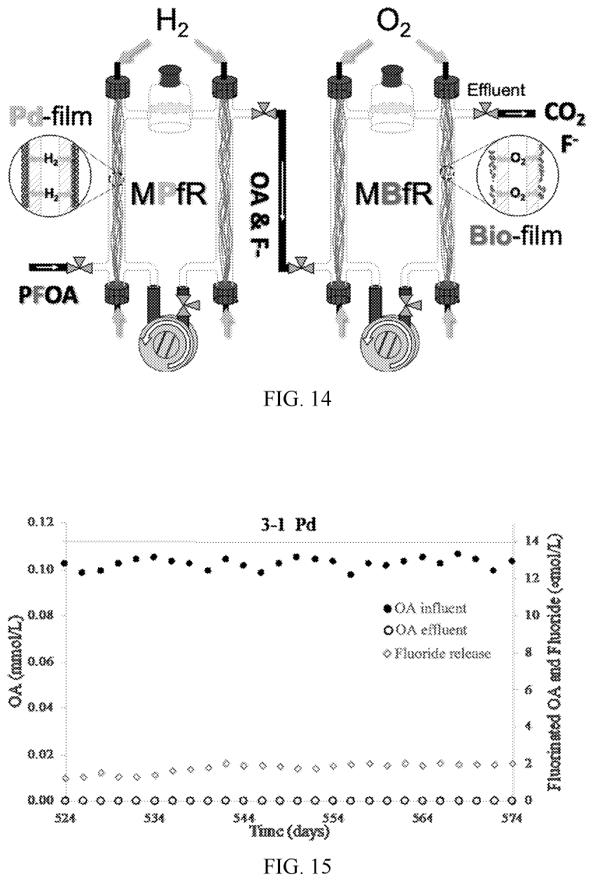

In this example, a bench-scale system featuring biofilms was prepared in ambient conditions (23° C. and 1 atm). The system has a dual-tube design as shown in FIG. 12. The system, having a total working volume of 75 ml, contained a main bundle with 50 hollow-fiber membranes (nonporous gas-transfer membrane, 280 μm OD, 180 μm ID, wall thickness 50 μm) and a “coupon” bundle with 10 same composite fibers in two glass tube, respectively. Each fiber was 24-cm long, giving a total membrane surface of 120 cm². Pure oxygen gas was supplied to all the ends of fiber bundles at different pressures controlled by a pressure regulator. The solute's concentration inside the reactor was kept equal to its effluent concentration by mixing with a recirculating pump at a rate of 150 ml/min.

The system was first inoculated with aerobic sludge from a local wastewater reclamation plant, and then submerged with the a microorganism enrichment medium containing 144 mg/L octanoic acid, 994 mg/L Na₂HPO₄, 840 mg/L NaH₂PO₄, 1.66 mg/L Ca(NO₃)₂, 1.48 mg/L Mg(NO₃)₂, 0.1 mg/L ZnSO₄·7H₂O, 0.03 mg/L MnCl₂·4H₂O, 0.3 mg/L H₃BO₃, 0.2 mg/L CoCl₂·6H₂O, 0.01 mg/L CuCl₂·2H₂O, 0.01 mg/L NiCl₂·6H₂O, 0.03 mg/L Na₂MoO₄·2H₂O, and 0.03 mg/L Na₂SeO₃. The system was left in batch mode overnight and then continuously fed with the microorganism enrichment medium for one month. After the one month, a thick, mature biofilm had formed on the membrane surfaces. The biofilm could completely oxidize 0.1 mM octanoic acid in continuous operation with HRT of 12 hours.

In a long-term continuous operation of O₂-MBfR, the reactor was fed with two different fluorinated octanoic acids (2-fluorooctanoic acid ‘2-FOA’ and 2H,2H-perchlorooctanoic acid ‘2H-PFOA’) and octanoic acid (OA) (FIG. 5A). In stage 1-1, the biofilm was enriched with OA as the only substrate. After long-term enrichment, the reactor achieved over 99% of 0.5 mM OA removal. Then, the reactor was fed with 2-FGA of different influent concentration. In stage 1-4, featuring 0.5 mM OA and 0.01 mM 2-FGA in the influent, the removal of 2-FOA was stable at about 99% for more than 10 days. The results reveal that continuous substantial removal of 2-FOA with OA as primary substrate was possible for a long-term steady state. It documents that a high level of defluorination makes the fluorinated species biodegradable.

After stages 1-1 to 1-4, the mono-fluorinated 2-FGA was replaced with trideca-fluorinated 1,1-dihydro-perfluorinated OA (2H-PFOA, PFOA with two Fs replaced by two Hs) at different concentrations in Stages 2 (FIG. 5B) to test the effects of a more fluorinated OA on the biofilm. At the end of Stage 2-2, OA removal remained >99%, while 2H-PFOA removal gradually increased to 15% along with 1.0 μM of released F⁻ (13% of the total F in the removed 2H-PFOA). In Stages 2-2, the influent concentration of OA was decreased to 0.1 mM for a higher 2H-PFOA/OA mole ratio to 1/20 in order to selectively enrich 2H-PFOA-oxidizing bacteria. OA removal remained >99% throughout the stage, while 2H-PFOA removal remained 16% at the end of the stage, with no significant improvement of the 2H-PFOA biodegradability from Stage 2-2. In Stage 2-4, OA was removed from the influent to selectively enrich the functional bacteria capable of degrading highly fluorinated OA without OA. In the last two weeks, a ~24% slowdown of 2H-PFOA removal and F⁻ release was observed, probably caused by biomass loss for energy deficiency (90% less energy input without OA). The trend reinforces that a primary substrate (like OA) is crucial to support biofilm growth and the initial steps of reductive defluorination.

In stage 2-5, the system was added back 0.1 mM OA to the influent as the primary substrate to support the biofilm growth and 2H-PFOA biodegradation. In the first 6 days, the removal of OA increased from 55% to over 99%, which indicated that the biofilm still was capable of utilizing OA as carbon and energy source, but it needed to have new synthesis to regain its early performance for OA removal; this coincides with our explanation of the gradual loss of 2H-PFOA removal. The released F⁻ concentration also increased from 1.8 to 8.6 μM, which accounts for about 14% of the total fluorine in the removed 2H-PFOA. The latest molar ratio of released F⁻ to removed 2H-PFOA was about 1.8.

In stage 2-6, the influent was added 10 mM PFOA to investigate the potential for PFOA biodegradation and its inhibition effect on 2H-PFOA biodegradation. In the first month, the removal of OA did not change, staying over 99%. 2H-PFOA remained at steady-state removal of 48% (or a flux of 18.3 mg/m²/d). The released F⁻ concentration was 8.6 μM, which accounts for about 14% of the total fluorine in the removed 2H-PFOA. The latest molar ratio of released F⁻ to removed 2H-PFOA was about 1.8. The effluent concentration of PFOA was decreased by <8% of the influent during the initial 14 days, but it gradually increased back to 97% of the influent. This suggests initial adsorption followed by desorption of PFOA to the reactor material or the biofilm. Overall, the 28-day results of Stage 2-6 reveal that PFOA probably was not biodegraded, but its presence had no acute effect on biodegradation of partial- or non-fluorinated OA.

In stage 2-7, 2H-PFOA was removed from the influent, which left 10 μM PFOA and 100 μM OA as the substrates. The removal of OA did not change, staying over 99%. The effluent concentration of F⁻ was constantly below 0.1 μM, indicating that PFOA was not defluorinated through biodegradation in O₂-MBfR. In stage 2-8, the PFOA in influent was removed and 10 μM 2H-PFOA added. The removal of OA did not change, staying over 99%. Within one day after 2H-PFOA re-introduction, the 2H-PFOA removal bounced back to 40%, and the system soon reached steady-state for 48% removal (or a flux of 18.3 mg/m²/d). Accordingly, the released F⁻ concentration reached 8.6 μM, which accounts for about 14% of the total fluorine in the removed 2H-PFOA, or 1.8 of the molar ratio of released F⁻ to removed 2H-PFOA; these values are close to those in the previous 2H-PFOA stage (Stage 2-6) before the PFOA test. Overall, the 14-day results of Stage 2-8 reveal that the biofilm maintained its capability of 2H-PFOA biodegradation and was ready for PFOA reductive defluorination products biodegradation tests.

### 3. Synergistic Operation of Both Catalytic Reductive Dechlorination and Oxidative Biodegradation

In this example, after achieving stable reductive defluorination of PFOA in the H₂-MPfR and biodegradation of octanoic acid in the O₂-MBfR, the two parts were connected the two reactors by linking the effluent tube of H₂-MPfR to the influent tube of O₂-MBfR; this is illustrated in FIG. 12. In the synergistic system, PFOA was reductively defluorinated in H₂-MPfR and converted to less- or none-fluorinated octanoic acid. The defluorinated products were further oxidize in the O₂-MBfR by the biofilm with or without octanoic acid as extra substrate.

To test the synergistic operation, the O₂-MBfR was fed with the H₂-MPfR effluent solution featuring 7 μM remaining PFOA, 2 μM F⁻, and unidentified defluorinated products (FIG. 13). 0.1 mM OA was added in the solution as the primary electron donor. The removal of OA did not change, staying over 99%; this confirms that the products from H₂-MPfR had no observable inhibition on OA biodegradation. After two months enrichment, the effluent F⁻ changes (difference between influent and effluent concentration) gradually increased from 1.5 μM to 2.0 μM and reached steady-state, indicating that the biofilm needed time to adapt to the new substrates (products of H₂-based defluorination). According to HPLC-MS-MS results of O₂-MBfR effluent from day 524 to 538 (first two weeks of stage 3-1), the dominant shorter chain per-fluorinated carboxylic acid (as determined by relatively high peak area) was perfluorohexanoic acid (C6) with trace-level heptafluorobutyric acid (C4). These two biodegradation products indicate that the defluorinated products in the collected H₂-MPfR effluent could be 2H-PFOA and 6H-PFOA:

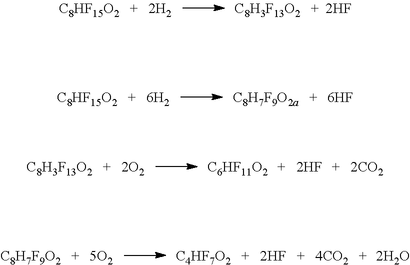

Other highly defluorinated products, like monofluorooctanoic acid and difluorooctanoic acid, also could be completely mineralized in the O2-MBfR. The residual PFOA in the MBfR effluent was about 7 μM, no significant removal was observed compared to MPfR effluent.

What is claimed:

1. A method of establishing a system for removing per- and polyfluoroalkyl substances (PFAS) from a fluid, the method comprising:
(i) providing a first nonporous membrane, wherein the first nonporous membrane comprises a gas-phase side and a liquid-phase side;
(ii) contacting the liquid-phase side of the first nonporous membrane with a catalyst-precursor medium, the catalyst-precursor medium comprising a precious metal salt and a solvent; and
(iii) contacting the gas-phase side of the first nonporous membrane with hydrogen (H₂) gas at a sufficient partial pressure to convert at least 90% of the precious metal salt in the catalyst-precursor medium to elemental form, wherein the elemental form of the precious metal is in the form of nanoparticles and is deposited on the liquid-phase side of the first nonporous membrane to form a monometallic catalyst film configured to reduce PFAS to less fluorinated counterparts, wherein the nanoparticles of the monometallic catalyst film have diameters of less than 10 nm.

2. The method of claim 1, wherein the precious metal concentration in the catalyst-precursor medium is 0.01-100 mM.

3. The method of claim 1, wherein the pH of the catalyst-precursor medium is 6-8.

4. The method of claim 1, further comprising:
submerging a second nonporous membrane with a microorganism-enrichment medium comprising an organic carbon source;
contacting an inoculant with the second nonporous membrane, wherein the inoculant comprises heterotrophs capable of oxidizing partially fluorinated or non-fluorinated alkyl acids; and
pressurizing the gas-phase side of the second nonporous membrane with oxygen (O₂) gas at desired partial pressure, thereby forming a biofilm on the liquid-phase side of the second nonporous membrane that metabolizes the less fluorinated counterparts of PFAS.

5. The method of claim 4, wherein the microorganism-enrichment medium further comprises salts of macronutrients, salts of micronutrients, and/or phosphate salts.

6. The method of claim 4, wherein the first nonporous membrane is in a first reactor and the second nonporous membrane is in a second reactor, wherein the second reactor is in fluid connection with the first reactor.

7. The method of claim 4, wherein the fluid comprising PFAS flows at a hydraulic retention time (HRT) of no more than 24 hours.

8. The method of claim 4, wherein each of the first nonporous membrane and the second nonporous membrane is a hollow-fiber membrane.

9. A method of establishing a system for removing per- and polyfluoroalkyl substances (PFAS) from a fluid, the method comprising:
(iv) providing a first nonporous membrane and a second nonporous membrane, wherein each of the first nonporous membrane and the second nonporous membrane comprises a gas-phase side and a liquid-phase side;
(v) forming a monometallic catalyst film of nanoparticles having diameters of less than 10 nm on the liquid-phase side of the first nonporous membrane;
(vi) configuring the catalyst film to reduce PFAS to less fluorinated counterparts; forming a biofilm on the liquid-phase side of the second nonporous membrane; and configuring the biofilm to metabolize the less fluorinated counterparts of PFAS.

10. The method of claim 9, wherein forming the catalyst film comprises contacting the liquid-phase side of the first nonporous membrane with a catalyst-precursor medium, the catalyst-precursor medium comprising a precious metal salt and a solvent.

11. The method of claim 10, wherein forming the catalyst film further comprises contacting the gas-phase side of the first nonporous membrane with hydrogen (H₂) gas at a sufficient partial pressure to convert at least 90% of the precious metal salt in the catalyst-precursor medium to elemental form, wherein the elemental form of the precious metal is deposited on the liquid-phase side of the first nonporous membrane to form the monometallic catalyst film.

12. The method of claim 10, wherein the precious metal concentration in the catalyst-precursor medium is 0.01-100 mM.

13. The method of claim 10, wherein the pH of the catalyst-precursor medium is 6-8.

14. A method of establishing a system for removing per- and polyfluoroalkyl substances (PFAS) from a fluid, the method comprising:
(vii) providing a first nonporous membrane and a second nonporous membrane;
(viii) forming a monometallic catalyst film of nanoparticles on the first nonporous membrane;
(ix) configuring the catalyst film to reduce PFAS to less fluorinated counterparts;
forming a biofilm on the second nonporous membrane; and
configuring the biofilm to metabolize the less fluorinated counterparts of PFAS.

15. The method of claim 14, wherein the nanoparticles of the catalyst film have diameters of less than 10 nm.

16. The method of claim 14, wherein each of the first nonporous membrane and the second nonporous membrane comprises a gas-phase side and a liquid-phase side, wherein the catalyst film is formed on the liquid-phase side of the first nonporous membrane and the biofilm is formed on the liquid-phase side of the second nonporous membrane.

17. The method of claim 16, wherein forming the catalyst film comprises contacting the liquid-phase side of the first nonporous membrane with a catalyst-precursor medium, the catalyst-precursor medium comprising a precious metal salt and a solvent.

18. The method of claim 16, wherein forming the catalyst film further comprises contacting the gas-phase side of the first nonporous membrane with hydrogen (H₂) gas at a sufficient partial pressure to convert at least 90% of the precious metal salt in the catalyst-precursor medium to elemental form, wherein the elemental form of the precious metal is deposited on the liquid-phase side of the first nonporous membrane to form the monometallic catalyst film.

19. The method of claim 16, wherein the precious metal concentration in the catalyst-precursor medium is 0.01-100 mM.

20. The method of claim 16, wherein the pH of the catalyst-precursor medium is 6-8.
